(19) United States
(12) Patent Application Publication
(10) Pub. No.: US 2014/0322498 A1
(43) Pub. Date: Oct. 30, 2014

(54) CONDUCTIVE VINYL MATTING

(71) Applicants: James R. May, Marietta, GA (US); Gary A. Ort Mertl, Cartersville, GA (US); John R. Beck, Cartersville, GA (US); Vickie Jordan, Cartersville, GA (US)

(72) Inventors: James R. May, Marietta, GA (US); Gary A. Ort Mertl, Cartersville, GA (US); John R. Beck, Cartersville, GA (US); Vickie Jordan, Cartersville, GA (US)

(21) Appl. No.: 13/872,131

(22) Filed: Apr. 28, 2013

(51) Int. Cl. B32B 27/12; B32B 27/30; B32B 5/02

(52) U.S. Cl. CPC B32B 27/12; B32B 5/022; B32B 27/304; B32B 2307/202; B32B 2307/21; B32B 2327/06
USPC 428/192; 156/60; 156/220; 442/396; 428/196

(57) ABSTRACT

Conductive vinyl matting and associated methods of manufacture and use are disclosed. In at least one embodiment, a conductive vinyl matting that is conductive on one side and static dissipative on the opposite side is disclosed. A method of manufacturing a conductive vinyl matting that is conductive on one side and static dissipative on the opposite side is also disclosed.

### FIELD OF THE INVENTION

The technology described herein relates generally to the fields of matting solutions, covering materials, conductive flooring products, thermoplastics, plastisols, static dissipative products, and electrostatics. More specifically, this technology relates to conductive vinyl matting and associated methods of manufacture and use. Still furthermore, this technology relates to conductive vinyl matting that is conductive on one side and static dissipative on the opposite side, and associated methods of manufacture and use.

### BACKGROUND OF THE INVENTION

Matting solutions are known in the background art to include flooring mats and table top mats. By way of example, plastic mats or runners are commonly employed to provide cushioning and shock-absorbing covering surfaces for objects or people. In particular, polyvinyl chloride (PVC) plastic mats and runners composed of vinyl foam or solid layers, or combinations thereof, are often used as flexible surface coverings. By way of example, such mats are often utilized in areas containing sensitive electronic equipment, such as in clean rooms. The mats are often treated or manufactured to have static-reducing properties in order to reduce static charges which build up on persons or objects. The static-reducing surface covering material is electrically conductive and is antistatic in the sense that it reduces static and prevents the generation of a substantially instantaneous spark discharge, and yet is sufficiently electrically resistant so as not to be wholly electrically conductive and to control the discharge of accumulated static.

### BRIEF SUMMARY OF THE INVENTION

In various exemplary embodiments, the technology described herein provides conductive vinyl matting and associated methods of manufacture and use.

In one exemplary embodiment, the technology described herein provides a conductive vinyl matting that is conductive on one side and static dissipative on the opposite side. The conductive vinyl matting includes: a flexible thermoplastic polymer layer, and an electrically conductive, non-woven fibrous sheet material layer adapted for disposition upon, combination with, and solidification by heat with a topside surface of the flexible thermoplastic polymer layer, while the flexible thermoplastic polymer layer is in a plastisol form. The combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state. By such combination and solidification, the conductive vinyl matting is thereby made conductive on the topside surface, and made static dissipative on the underside surface. The conductive vinyl matting thereby is adapted to provide a conductive surface over any surface upon which it is applied.

In at least one embodiment of the conductive vinyl matting, the flexible thermoplastic polymer layer comprises polyvinyl chloride (PVC).

In at least one embodiment of the conductive vinyl matting, the flexible thermoplastic polymer layer comprises a static dissipative amount of a static-reducing additive agent therein.

In at least one embodiment of the conductive vinyl matting, the electrically conductive, non-woven fibrous sheet material layer comprises a carbon veil.

In at least one embodiment of the conductive vinyl matting, the electrically conductive, non-woven fibrous sheet material layer comprises randomly-oriented polyester fiber.

In at least one embodiment of the conductive vinyl matting, a total gauge of the conductive vinyl matting, including the flexible thermoplastic polymer layer and the electrically conductive, non-woven fibrous sheet material layer is selected from within a range within 0.05 inches and 0.15 inches.

In at least one embodiment of the conductive vinyl matting, a gauge of the electrically conductive, non-woven fibrous sheet material layer is selected from within a range within 0.001 inches and 0.010 inches.

In at least one embodiment, the conductive vinyl matting further includes at least one safety border defined upon at least one longitudinal edge of the combined and solidified flexible thermoplastic polymer layer and electrically conductive, non-woven fibrous sheet material layer.

In at least one embodiment, the conductive vinyl matting is a flooring mat. In at least one alternative embodiment, the conductive vinyl matting is a table top mat.

In at least one embodiment, the conductive vinyl matting includes a non-directional and lineal pattern defined within a top surface of the conductive vinyl matting. In at least one alternative embodiment, the conductive vinyl matting includes a textured pattern defined within the top surface of the conductive vinyl matting.

In another exemplary embodiment, the technology described herein provides a method for producing a conductive vinyl matting that is conductive on one side and static dissipative on the opposite side. The method includes: utilizing a flexible thermoplastic polymer layer; utilizing an electrically conductive, non-woven fibrous sheet material layer adapted for disposition upon, combination with, and solidification by heat with a topside surface of the flexible thermoplastic polymer layer, while the flexible thermoplastic polymer layer is in a plastisol form; disposing the electrically conductive, non-woven fibrous sheet material layer upon the flexible thermoplastic polymer layer; combining the electrically conductive, non-woven fibrous sheet material layer with the flexible thermoplastic polymer layer; transferring the electrically conductive, non-woven fibrous sheet material layer upon the flexible thermoplastic polymer layer through an oven; and heating, in the oven, or curing, or fusing, the electrically conductive, non-woven fibrous sheet material layer upon the flexible thermoplastic polymer layer, while the flexible thermoplastic polymer layer is in a plastisol form.

In this embodiment, the combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state. In this method, by such combination and solidification, the conductive vinyl matting is thereby made conductive on the topside surface, and made static dissipative on the underside surface. In this method, the conductive vinyl matting thereby is adapted to provide a conductive surface over any surface upon which it is applied.

In at least one embodiment, the method also includes embossing a pattern into the electrically conductive, non-woven fibrous sheet material layer to set the electrically conductive, non-woven fibrous sheet material layer into the flexible thermoplastic polymer layer.

In at least one embodiment, the method further includes utilizing an embossing roller to emboss the pattern into the electrically conductive, non-woven fibrous sheet material layer to set the electrically conductive, non-woven fibrous sheet material layer into the flexible thermoplastic polymer layer.

In at least one embodiment, the method also includes setting the electrically conductive, non-woven fibrous sheet material layer into the flexible thermoplastic polymer layer, such that the electrically conductive, non-woven fibrous sheet material layer is embedded within the flexible thermoplastic polymer layer.

In at least one embodiment, the method also includes forming a pattern with the embossing roller on a top surface of the conductive vinyl matting.

In at least one embodiment of the method, a total gauge of the conductive vinyl matting, including the flexible thermoplastic polymer layer and the electrically conductive, non-woven fibrous sheet material layer is selected from within a range within 0.05 inches and 0.15 inches.

In at least one embodiment of the method, a gauge of the electrically conductive, non-woven fibrous sheet material layer is selected from within a range within 0.001 inches and 0.010 inches.

In yet another exemplary embodiment, the technology described herein provides a conductive vinyl floor mat, which is conductive on one side and static dissipative on the opposite side. The conductive vinyl floor mat includes: a flexible thermoplastic polymer layer of polyvinyl chloride (PVC) and having a static dissipative amount of a static-reducing additive agent therein, and an electrically conductive, non-woven fibrous sheet material layer of randomly-oriented polyester fiber carbon veil adapted for disposition upon, combination with, and solidification by heat with a topside surface of the flexible thermoplastic polymer layer, while the flexible thermoplastic polymer layer is in a plastisol form. The combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state. By such combination and solidification, the conductive vinyl matting is thereby made conductive on the topside surface, and made static dissipative on the underside surface. The conductive vinyl matting thereby is adapted to provide a conductive surface over any surface upon which it is applied.

In at least one embodiment of the conductive vinyl floor mat, a total gauge of the conductive vinyl floor mat, including the flexible thermoplastic polymer layer and the electrically conductive, non-woven fibrous sheet material layer is selected from within a range within 0.075 inches and 0.100 inches. In at least one embodiment of the conductive vinyl floor mat, a gauge of the electrically conductive, non-woven fibrous sheet material layer is selected from within a range within 0.001 inches and 0.010 inches.

In yet another exemplary embodiment, the technology described herein provides a conductive vinyl table top mat, that is conductive on one side and static dissipative on the opposite side, the table top mat comprising: a flexible thermoplastic polymer layer of polyvinyl chloride (PVC) and having a static dissipative amount of a static-reducing additive agent therein, and an electrically conductive, non-woven fibrous sheet material layer of randomly-oriented polyester fiber carbon veil adapted for disposition upon, combination with, and solidification by heat with a topside surface of the flexible thermoplastic polymer layer, while the flexible thermoplastic polymer layer is in a plastisol form. The combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state. By such combination and solidification, the conductive vinyl matting is thereby made conductive on the topside surface, and made static dissipative on the underside surface. The conductive vinyl matting thereby is adapted to provide a conductive surface over any surface upon which it is applied.

In at least one embodiment of the conductive vinyl table top mat, a total gauge of the conductive vinyl table top mat, including the flexible thermoplastic polymer layer and the electrically conductive, non-woven fibrous sheet material layer is selected from within a range within 0.05 inches and 0.15 inches; and wherein a gauge of the electrically conductive, non-woven fibrous sheet material layer is selected from within a range within 0.001 inches and 0.010 inches.

Advantageously, the conductive vinyl matting, systems, and associated methods described herein provide solutions such as flooring mats and/or table top mat for areas containing sensitive electronic equipment, such as in clean rooms, by way of example, and not of limitation. The mats have static-reducing properties in order to reduce static charges which build up on persons or objects.

Also advantageously, the conductive vinyl matting, systems, and associated methods described herein provide a static-reducing surface covering material that is electrically conductive and is antistatic in the sense that it dissipates static and prevents the generation of a substantially instantaneous spark discharge. The mat is sufficiently electrically resistant so as not to be wholly electrically conductive and to control the discharge of accumulated static. The mat is grounded in at least one embodiment.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a flowchart diagram illustrating an exemplary method to manufacture and use conductive vinyl matting that is conductive on one side and static dissipative on the opposite side, according to an embodiment of the technology described herein;

FIG. 2 is an enlarged, cross-sectional view of a conductive vinyl matting manufactured by the exemplary method depicted in FIG. 1, and illustrating, in particular, a PVC composite material, a carbon veil applied to the PVC, and an embossed random, non-directional pattern created as the PVC and carbon veil heated and embossed according to the method, according to an embodiment of the technology described herein;

FIG. 3 is an enlarged, cross-sectional view of a conductive vinyl matting manufactured by the exemplary method depicted in FIG. 1, and illustrating, in particular, a PVC composite material, a carbon veil disposed upon the PVC, and an embossed texture pattern created as the PVC and carbon veil heated and embossed according to the method, according to an embodiment of the technology described herein; and

FIG. 4 is a top view of conductive vinyl matting manufactured by the exemplary method depicted in FIG. 1, and illustrating, in particular, additional safety borders, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides conductive vinyl matting and various associated methods of manufacture and use. By way of example, the conductive vinyl matting can be used for flooring mats, table top mats, and so forth. The conductive vinyl matting is adapted to provide cushioning and shock-absorbing covering surfaces for objects or people. The conductive vinyl matting, in various embodiments, can also include multiple layers, foam, edges, adhesives for application to a surface, and so forth.

The conductive vinyl matting is useful for scenarios in which a need exists to reduce static and to prevent the generation of a substantially instantaneous spark discharge, and yet is sufficiently electrically resistant so as not to be wholly electrically conductive and to control the discharge of accumulated static.

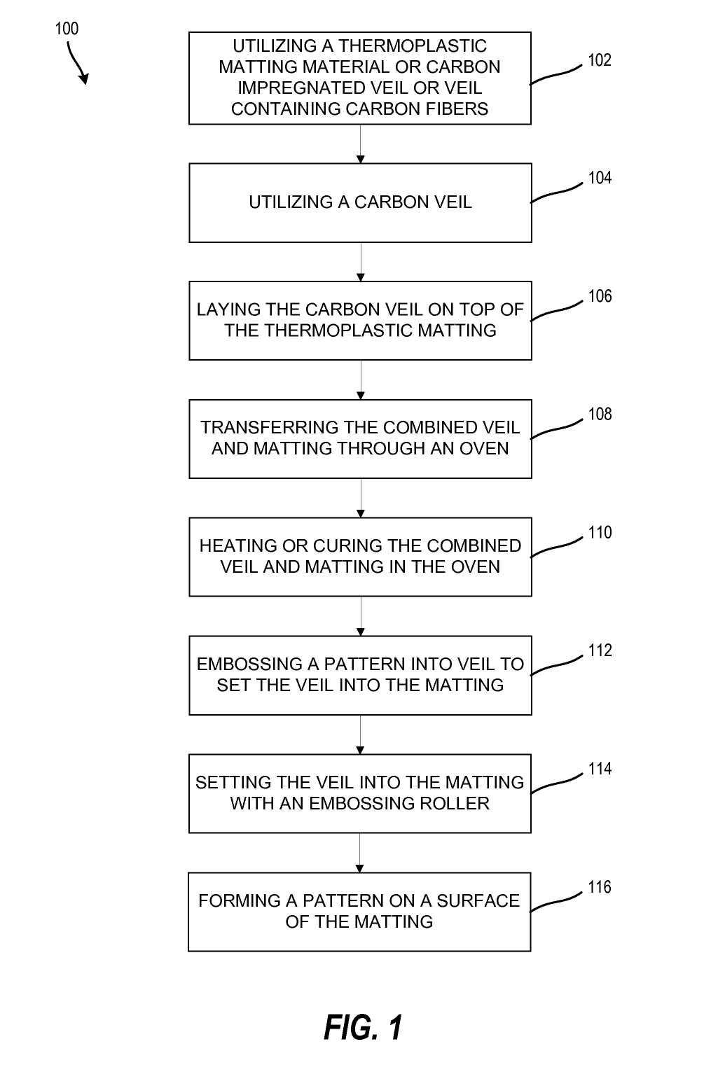

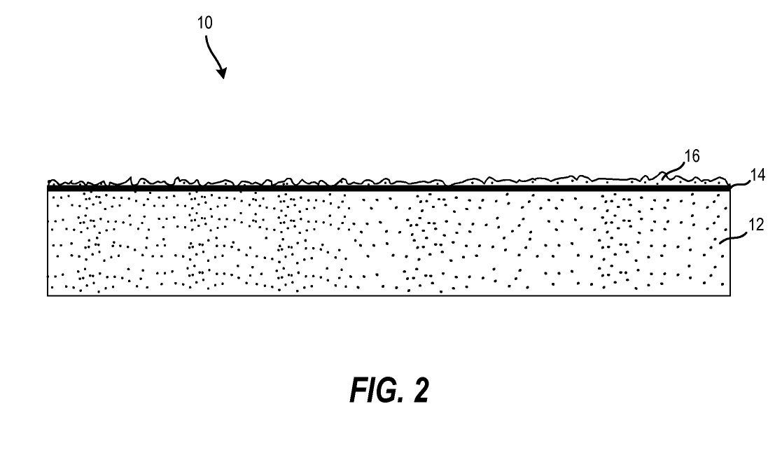

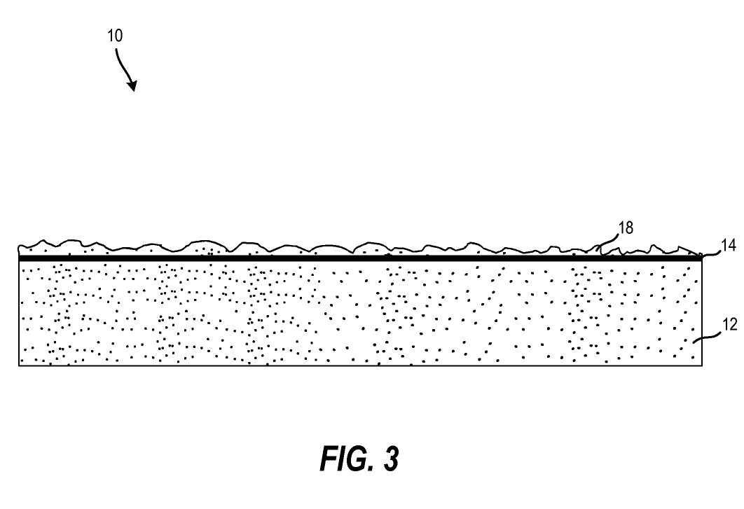

Referring now to FIGS. 2 and 3, an enlarged, cross-sectional view of a conductive vinyl matting 10, manufactured by the exemplary method steps depicted in FIG. 1, is shown. These figures are enlarged and are not drawn to scale, as the top layer, for example, is very thin relative to the bottom layer, but is shown enlarged to be visible.

The conductive vinyl matting 10 includes a flexible thermoplastic polymer layer 12. In at least one embodiment of the conductive vinyl matting 10, the flexible thermoplastic polymer layer 12 comprises polyvinyl chloride (PVC). In at least one embodiment of the conductive vinyl matting 10, the flexible thermoplastic polymer layer 12 comprises a static dissipative amount of a static-reducing additive agent therein.

The conductive vinyl matting 10 includes an electrically conductive, non-woven fibrous sheet material layer 14. The electrically conductive, non-woven fibrous sheet material layer 14 is adapted for disposition upon, combination with, and solidification by heat with a topside surface of the flexible thermoplastic polymer layer, while the flexible thermoplastic polymer layer is in a plastisol form. In at least one embodiment of the conductive vinyl matting 10, the electrically conductive, non-woven fibrous sheet material layer 14 comprises a carbon veil, or what is often called a carbon fleece. In at least one embodiment of the conductive vinyl matting 10, the electrically conductive, non-woven fibrous sheet material layer 14 comprises randomly-oriented polyester fiber.

The combined and solidified flexible thermoplastic polymer layer 12 and electrically conductive, non-woven fibrous sheet material layer 14 are adapted for an emboss roller process, while the combined and solidified flexible thermoplastic polymer layer and electrically conductive, non-woven fibrous sheet material layer are in a malleable state.

By such combination and solidification, the conductive vinyl matting 10 is thereby made conductive on the topside surface, and made static dissipative on the underside surface. The conductive vinyl matting 10 thereby is adapted to provide a conductive surface over any surface upon which it is applied.

In at least one embodiment of the conductive vinyl matting 10, a total gauge of the conductive vinyl matting 10, including the flexible thermoplastic polymer layer 12 and the electrically conductive, non-woven fibrous sheet material layer 14 is selected from within a range within 0.075 inches and 0.100 inches.

In at least one embodiment of the conductive vinyl matting 10, a gauge of the electrically conductive, non-woven fibrous sheet material layer 14 is selected from within a range within 0.001 inches and 0.010 inches.

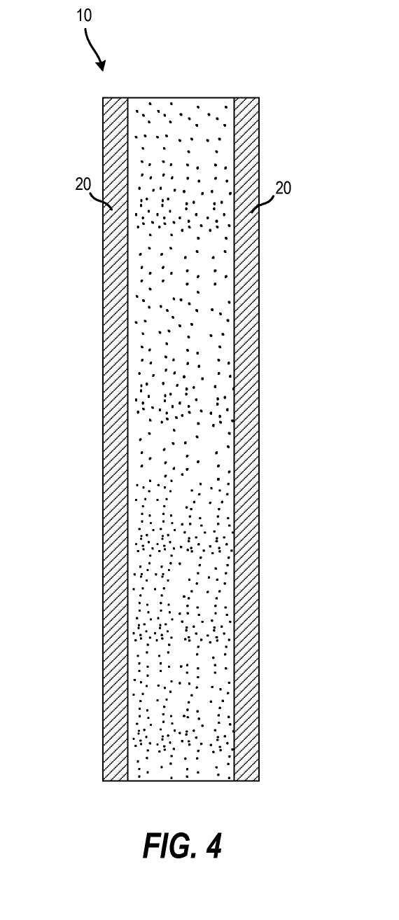

In at least one embodiment, and as specifically depicted in FIG. 4, the conductive vinyl matting 10 further includes at least one safety border 20 defined upon at least one longitudinal edge of the combined and solidified flexible thermoplastic polymer layer 12 and electrically conductive, non-woven fibrous sheet material layer 14.

In at least one embodiment, the conductive vinyl matting 10 is a flooring mat. In at least one alternative embodiment, the conductive vinyl matting 10 is a table top mat.

In at least one embodiment, the conductive vinyl matting 10 includes a non-directional and lineal pattern 16 defined within a top surface of the conductive vinyl matting 10, as depicted specifically in FIG. 2. In at least one alternative embodiment, the conductive vinyl matting 10 includes a textured pattern 18 defined within a top surface of the conductive vinyl matting as depicted specifically in FIG. 3.

Referring now to FIG. 1, a flowchart diagram 100 is depicted, illustrating exemplary methods steps to manufacture and use conductive vinyl matting that is conductive on one side and static dissipative on the opposite side.

At step 102, the method includes utilizing a flexible thermoplastic polymer layer. This method step, in a varied embodiment, also can include utilizing a carbon impregnated veil. This method step, in a varied embodiment, also can include utilizing a veil containing carbon fibers.

At step 104, the method includes utilizing an electrically conductive, non-woven fibrous sheet material layer. The electrically conductive, non-woven fibrous sheet material layer is adapted for disposition upon, combination with, and solidification by heat with a topside surface of the flexible thermoplastic polymer layer, while the flexible thermoplastic polymer layer is in a plastisol form.

At step 106, the method includes disposing the electrically conductive, non-woven fibrous sheet material layer upon the flexible thermoplastic polymer layer; and combining the electrically conductive, non-woven fibrous sheet material layer with the flexible thermoplastic polymer layer.

At step 108, the method includes transferring the electrically conductive, non-woven fibrous sheet material layer upon the flexible thermoplastic polymer layer through an oven.

At step 110, the method includes heating, in the oven, or curing, or fusing, the electrically conductive, non-woven fibrous sheet material layer upon the flexible thermoplastic polymer layer, while the flexible thermoplastic polymer layer is in a plastisol form. This method step, in a varied embodiment, also can include curing.

At step 112, the method includes embossing a pattern into the electrically conductive, non-woven fibrous sheet material layer to set the electrically conductive, non-woven fibrous sheet material layer into the flexible thermoplastic polymer layer. This method step 112 also can include utilizing an embossing roller to emboss the pattern into the electrically conductive, non-woven fibrous sheet material layer to set the electrically conductive, non-woven fibrous sheet material layer into the flexible thermoplastic polymer layer.

At step 114, the method includes setting the electrically conductive, non-woven fibrous sheet material layer into the flexible thermoplastic polymer layer, such that the electrically conductive, non-woven fibrous sheet material layer is embedded within the flexible thermoplastic polymer layer.

At step 116, the method includes forming a pattern with the embossing roller on a top surface of the conductive vinyl matting.

It will be apparent to those skilled in the art, after reading this disclosure, which methods steps disclosed can be performed simultaneously or in a different order than that depicted, or omitted given the nature of a particular procedure.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A conductive vinyl matting that is conductive on one side and static dissipative on the opposite side, the conductive vinyl matting comprising:
a flexible thermoplastic polymer layer, and
an electrically conductive, non-woven fibrous sheet material layer adapted for disposition upon, combination with, and solidification by heat with a topside surface of the flexible thermoplastic polymer layer, while the flexible thermoplastic polymer layer is in a plastisol form;
wherein the combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state;
wherein, by such combination and solidification, the conductive vinyl matting is thereby made conductive on the topside surface, and made static dissipative on the underside surface; and
wherein the conductive vinyl matting thereby is adapted to provide a conductive surface over any surface upon which it is applied.

2. The conductive vinyl matting of claim 1, wherein the flexible thermoplastic polymer layer comprises polyvinyl chloride (PVC).

3. The conductive vinyl matting of claim 1, wherein the flexible thermoplastic polymer layer further comprises a static dissipative amount of a static-reducing additive agent therein.

4. The conductive vinyl matting of claim 1, wherein the electrically conductive, non-woven fibrous sheet material layer comprises a carbon veil.

5. The conductive vinyl matting of claim 1, wherein the electrically conductive, non-woven fibrous sheet material layer comprises randomly-oriented polyester fiber.

6. The conductive vinyl matting of claim 1, wherein a total gauge of the conductive vinyl matting, including the flexible thermoplastic polymer layer and the electrically conductive, non-woven fibrous sheet material layer is selected from within a range within 0.05 inches and 0.15 inches.

7. The conductive vinyl matting of claim 1, wherein a gauge of the electrically conductive, non-woven fibrous sheet material layer is selected from within a range within 0.001 inches and 0.010 inches.

8. The conductive vinyl matting of claim 1, further comprising:
at least one safety border defined upon at least one longitudinal edge of the combined and solidified flexible thermoplastic polymer layer and electrically conductive, non-woven fibrous sheet material layer.

9. The conductive vinyl matting of claim 1, wherein the conductive vinyl matting is a flooring mat.

10. The conductive vinyl matting of claim 1, wherein the conductive vinyl matting is a table top mat.

11. The conductive vinyl matting of claim 1, further comprising:
a non-directional and lineal pattern defined within a top surface of the conductive vinyl matting.

12. The conductive vinyl matting of claim 1, further comprising:
a textured pattern defined within a top surface of the conductive vinyl matting.

13. A method for producing a conductive vinyl matting that is conductive on one side and static dissipative on the opposite side, the method comprising:
utilizing a flexible thermoplastic polymer layer;
utilizing an electrically conductive, non-woven fibrous sheet material layer adapted for disposition upon, combination with, and solidification by heat with a topside surface of the flexible thermoplastic polymer layer, while the flexible thermoplastic polymer layer is in a plastisol form;
disposing the electrically conductive, non-woven fibrous sheet material layer upon the flexible thermoplastic polymer layer;
combining the electrically conductive, non-woven fibrous sheet material layer with the flexible thermoplastic polymer layer;
transferring the electrically conductive, non-woven fibrous sheet material layer upon the flexible thermoplastic polymer layer through an oven; and
heating, in the oven, the electrically conductive, non-woven fibrous sheet material layer upon the flexible thermoplastic polymer layer, while the flexible thermoplastic polymer layer is in a plastisol form;
wherein the combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state;
wherein, by such combination and solidification, the conductive vinyl matting is thereby made conductive on the topside surface, and made static dissipative on the underside surface; and
wherein the conductive vinyl matting thereby is adapted to provide a conductive surface over any surface upon which it is applied.

14. The method of claim 13, further comprising:
embossing a pattern into the electrically conductive, non-woven fibrous sheet material layer to set the electrically conductive, non-woven fibrous sheet material layer into the flexible thermoplastic polymer layer.

15. The method of claim 14, further comprising:
utilizing an embossing roller to emboss the pattern into the electrically conductive, non-woven fibrous sheet material layer to set the electrically conductive, non-woven fibrous sheet material layer into the flexible thermoplastic polymer layer.

16. The method of claim 15, further comprising:
setting the electrically conductive, non-woven fibrous sheet material layer into the flexible thermoplastic polymer layer, such that the electrically conductive, non-woven fibrous sheet material layer is embedded within the flexible thermoplastic polymer layer.

17. The method of claim 16, further comprising:
forming a pattern with the embossing roller on the top surface of the conductive vinyl matting.

18. The method of claim 11, wherein a total gauge of the conductive vinyl matting, including the flexible thermoplastic polymer layer and the electrically conductive, non-woven fibrous sheet material layer is selected from within a range within 0.05 inches and 0.15 inches; and wherein a gauge of the electrically conductive, non-woven fibrous sheet material layer is selected from within a range within 0.001 inches and 0.010 inches.

19. A conductive vinyl floor mat, that is conductive on one side and static dissipative on the opposite side, the floor mat comprising:
a flexible thermoplastic polymer layer of polyvinyl chloride (PVC) and having a static dissipative amount of a static-reducing additive agent therein, and
an electrically conductive, non-woven fibrous sheet material layer of randomly-oriented polyester fiber carbon veil adapted for disposition upon, combination with, and solidification by heat with a topside surface of the flexible thermoplastic polymer layer, while the flexible thermoplastic polymer layer is in a plastisol form;
wherein the combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state;
wherein, by such combination and solidification, the conductive vinyl matting is thereby made conductive on the topside surface, and made static dissipative on the underside surface; and
wherein the conductive vinyl matting thereby is adapted to provide a conductive surface over any surface upon which it is applied.

20. The conductive vinyl floor mat or claim 19, wherein a total gauge of the conductive vinyl floor mat, including the flexible thermoplastic polymer layer and the electrically conductive, non-woven fibrous sheet material layer is selected from within a range within 0.05 inches and 0.15 inches; and wherein a gauge of the electrically conductive, non-woven fibrous sheet material layer is selected from within a range within 0.001 inches and 0.010 inches.

21. A conductive vinyl table top mat, that is conductive on one side and static dissipative on the opposite side, the table top mat comprising:
a flexible thermoplastic polymer layer of polyvinyl chloride (PVC) and having a static dissipative amount of a static-reducing additive agent therein, and
an electrically conductive, non-woven fibrous sheet material layer of randomly-oriented polyester fiber carbon veil adapted for disposition upon, combination with, and solidification by heat with a topside surface of the flexible thermoplastic polymer layer, while the flexible thermoplastic polymer layer is in a plastisol form;
wherein the combined and solidified flexible thermoplastic polymer layer and electrically conductive, non-woven fibrous sheet material layer are adapted for an emboss roller process, while the combined and solidified flexible thermoplastic polymer layer and electrically conductive, non-woven fibrous sheet material layer are in a malleable state;
wherein, by such combination and solidification, the conductive vinyl matting is thereby made conductive on the topside surface, and made static dissipative on the underside surface; and
wherein the conductive vinyl matting thereby is adapted to provide a conductive surface over any surface upon which it is applied.

22. The conductive vinyl table top mat or claim 21, wherein a total gauge of the conductive vinyl table top mat, including the flexible thermoplastic polymer layer and the electrically conductive, non-woven fibrous sheet material layer is selected from within a range within 0.05 inches and 0.15 inches; and wherein a gauge of the electrically conductive, non-woven fibrous sheet material layer is selected from within a range within 0.001 inches and 0.010 inches.
